(19) United States
(12) Patent Application Publication
(10) Pub. No.: US 2005/0190064 A1
(43) Pub. Date: Sep. 1, 2005

(54) Establishing a boundary zone, detecting intrusions, and identifying intruders who enter said zone

(75) Inventors: Michael P. McRory, San Diego, CA (US); Leslie J. Reading, Spring Valley, CA (US); Don A. Novotny, San Diego, CA (US)

Correspondence Address: Donald D. Mon, 750 East Green Street, Suite 303, Pasadena, CA, 91101, US

(73) Assignee: News/Sports Microwave Rental Inc.

(21) Appl. No.: 10/788,586

(22) Filed: Feb. 27, 2004

(51) Int. Cl. G08B 23/00

(52) U.S. Cl. 340/573.4; 340/552

(57) ABSTRACT

A barrier formed by a plurality of free-standing spaced-apart stations which are sensitive to events in a region between them. Each station includes a sensor responsive to an event to be sensed, and may be passive or a combination of emitter and sensor. The technology is preferably electromagnetic, or motion responsive.

### FIELD OF THE INVENTION

Protection, observation and enforcement of linear boundaries such as those of regional borders and sensitive areas, utilizing free standing affordable spaced-apart stations containing detectors responsive to intrusion, annunciators, and if desired visualizers, without requiring a structural barrier between adjacent stations.

### BACKGROUND OF THE INVENTION

Protection and enforcement of linear borders and boundaries around sensitive areas is a well-developed art, but one which fails to meet even reasonable needs for some applications. Systems for these employments are intended to fulfill a wide variety of requirements while enabling enforcement in an efficient, cost-effective, and readily maintained deployment.

The protection of a limited region by a peripheral fence, or of a border by a tall linear fence can be effective. If the linear extent of the fence is not too long, the high cost of such an installation can be afforded for very critical areas and regions. All that is needed to supplement it is a patrol to observe and resist intruders, and maintenance to repair damage done by attempted intruders. By itself the fence does not police intruders, but it is a substantial deterrent and first obstacle.

However, such installations are affordable only for very critical and not-too-long fences. An example is the United States border in Tijuana, Mexico. A tall expensive fence extends for a number of miles from the Pacific Ocean through a heavily congested urban region to a desolate area. The fence is backed by a roadway for patrols, and fitted with sensors to give notice of an intruder so as to invite the response of a guard. It also uses observation towers for visual backup.

While suitable for this type of limited application, such a fence is neither affordable nor efficient for the many trackless miles between towns along the border. They would soon be destroyed or penetrated, and the distances are so great as to be difficult to patrol. While detectors are often placed in such regions to alert the motion of an intruder, there is no ready means to distinguish a person from a mule, for example. Much time can be wasted investigating false alarms. Surveillance of such areas is often relegated to human trackers who patrol the border, looking for footprints. Fully visualizing camera systems installed along the boundary are a theoretical solution. However, the installation of a long range day/night pan tilt camera system is quite costly. Complete continuous visual coverage is not therefore only a good theory.

Vast tracts of land are left unaccounted for because presently available systems are too costly as well as subject to damage and evasion. These tracts must be covered by using valuable and limited manpower resources, whose effectiveness is inherently limited. The use of remote sensors and ground-based manpower can fill in areas not covered by cameras, but an unavoidably high number of false alarms and critical manpower shortages create shortcomings with this approach. When faced with multiple alarms, decisions must be made about which ones to pursue, leaving others un-checked the un-checked ones might be the critical ones that should have been checked.

Beyond this is the uncertainty of precisely where a border is. Absent a fence or of frequent markers, incursions from either side are known to incur, often unintentionally. It is difficult to object to the intrusion of an invisible border.

In what may be called less-critical regions, spaced apart observation devices such as remotely controlled cameras on towers are used. These can be turned and tilted to focus on regions to be observed, perhaps in response to a signal from a sensor. Intruders know where these cameras are, and where they are pointing. To frustrate these, the intruders need merely be where the camera is not looking, perhaps as part of a deceptive maneuver. Such surveillance is inherently inefficient and costly. Furthermore, a distant operator may be controlling a large number of these cameras, and can be overloaded, sometimes looking at a false alarm such as a mule instead of a person.

It is an object of this invention to provide a complete linear coverage pattern with reduced manpower requirements that is able to cover large tracts of land, utilizing rugged free standing unmanned stations spaced apart along a border or perimeter to be secured. The stations are not structurally interconnected such as by a fence or rail, but instead are inter-related in a sensing system. Each station is inherently able to detect intrusions and five notice of them which occur between itself and its adjacent station or stations, and this capability is used as part of a larger system.

Each station may further include a visualizer to image or otherwise identify whatever intruder alerts a situation, and inform a central station not only of the fact of the intrusion but in some situations even the identify of the intruder.

It is another object of this invention to provide the stations as cost-effective post-like structures that are readily maintained and which can be self-contained. They provide system integrity, and in some spaced apart relationships they can provide significant redundancy.

### BRIEF DESCRIPTION OF THE INVENTION

A system according to this invention comprises a plurality of linearly spaced-apart stations planted in the ground and extending above the surface of the ground. Each station is responsive to at least a portion (sector) of the region between it and its next-adjacent station, to form a sensing region. Sectors between adjacent stations either abut or overlap the sectors of its neighbors, and may also overlap the neighbor stations themselves.

This relationship establishes a continuous surveillance field. An intruder passing between adjacent stations (or in the surveillance region around an end station), will be detected and annunciated as the consequence of his or its interruption of the observed sector.

The surveillance field can be established in several ways, depending on the surveillance mode and the type of sensors being employed. Sensors responsive to radiation emitted by or reflected from the intruder, have many advantages. Other useful types of sensors are acoustic sensors, vibration sensors, thermal sensors, and visual sensors such as CCTV cameras able to alert and visualize changes in an optical field.

Whatever sensor type is used, signal processors in the station will respond and transmit to a supervisor the fact of intrusion and preferably where in the field it exists. The supervisor, in turn, will analyze the transmitted data and order a response to be made, or ignore it.

According to a preferred but optional feature of the invention, the station may be provided with remotely-controlled investigative means such as a directional camera equipped to be pointed toward the intrusion at the direction of the remote supervisor.

According to a preferred but optional feature of the invention, the stations are provided as upright posts for ready visibility and economical construction. These can serve as visible indications of the location of a border that is not to be crossed, and they can be readily be maintained.

According to yet to another preferred but optional feature of the invention, the sensing field of each station overlaps the next adjacent station or stations so as to provide redundancy in the event of failure of either of the stations.

Alternatively, the fields or their useful portions need not overlap the next stations, but while achieving continuity of barrier, they may not provide redundancy in the event of disablement of one of them. Still they are within the scope of this invention.

The above and other features of this invention will be fully understood from the following detailed description and the accompanying drawings, in which:

### BRIEF DESCRIPTION OF THE DRAWINGS

FIG. 1 is a schematic plan view showing the preferred embodiment of the invention;

FIG. 2 is a fragmentary schematic plan view of an alternate embodiment of the invention;

FIG. 3 is a schematic plan view of the details of one sector of the invention;

FIG. 4 is a schematic elevation view of a station according to the invention;

FIG. 5 is a schematic plan view showing the use of a visualizer; and

FIG. 6 is a schematic drawing showing a surveillance response system.

### DETAILED DESCRIPTION OF THE INVENTION

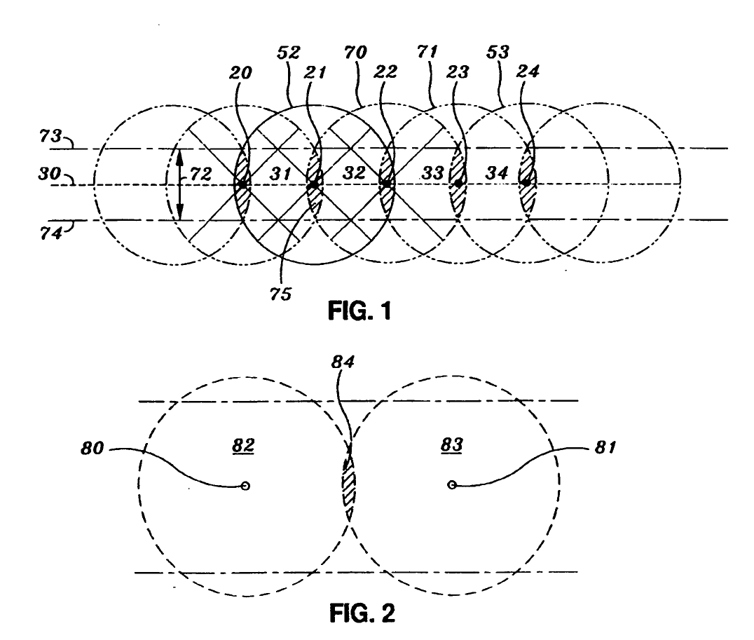

As best shown in FIG. 1 this invention is characterized by its use of a plurality of individual stations 20, 21, 22, 23 and 24. There may be any suitable number of such stations to fulfill the requirements of a specific application, perhaps more, perhaps fewer.

The intended result is to provide a linear invisible barrier 30, defined as the linear path between adjacent stations. For example, increment 31 between stations 20 and 21, and increment 32 between stations 21 and 22. Similar (although not necessarily equal) increments 33 and 34 exist between other stations along the perimeter. Their feature is that each increment is a link in the continuous barrier 30 along the stations. Such an increment will exist between each pair of adjacent stations.

Because all of the stations will be similarly fitted and adjusted for function, only station 22 will be described in detail. It is preferably provided as a strong structural post 40 set in the ground 41, preferably in a strong cement foundation 42. It can economically be formed from a strong heavy-walled tubing. It is intended to be free standing, and will be provided with its own power supply (not shown), such as a storage battery or solar cell system backed up with a battery. Engine powered generators could be used, but are generally unsuited for remote usage.

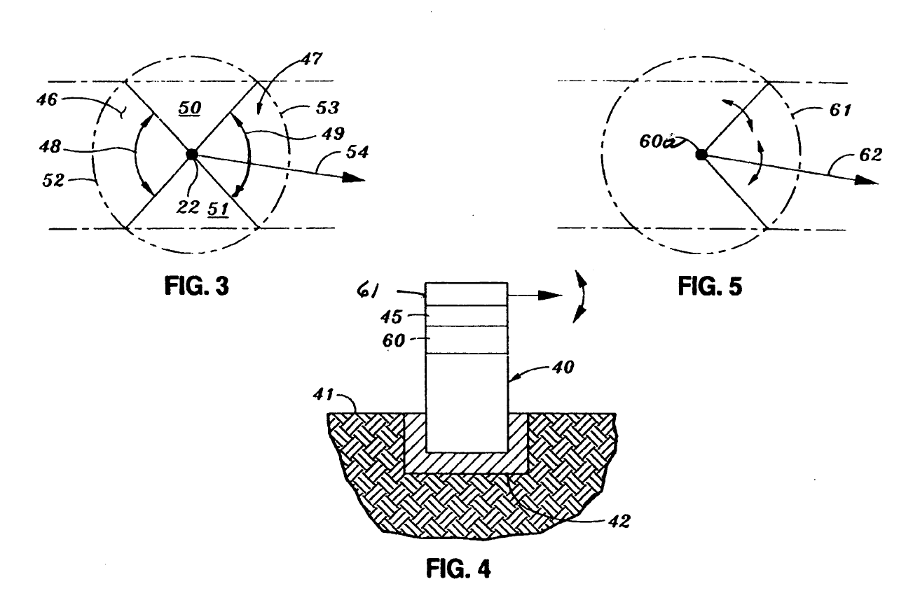

The presently preferred system includes an emitter 45 of electromagnetic energy which produces a surveillance field. An omni directional field, identical in all directions may be provided, but, as shown in FIGS. 1 and 3, some portions of it may be useless or even wasteful.

Field sectors 46 and 47 are oppositely directed toward adjacent stations 21 and 23, with included angles 48 and 49. Field sectors 50, 51 if generated, are of no importance in this detection arrangement.

Attention is called to arcs 52, 53 which define the outer-most extent of the field which is utilized. In FIG. 1, these arcs are shown extending past stations 21 and 23 so that these sectors overlap both adjacent sectors and also adjacent stations for redundancy purposes as will be seen. In FIG. 2, this situation does not exist.

Vector 54 in FIG. 3 indicates a directional sensitivity in the sector of the emitter. If desired, this sector could be set up by use of a rotating scanner (not shown) such as in a radar type system, in which event the location of an object in the field could be learned. With this invention, simpler devices can be used, because at least at first it is only necessary to learn that the field itself has been penetrated.

In whatever event, the necessary energy field is set up by the emitter, and any disruption in it is sensed by receiver (sometimes called an “annunciator”) 60 in the station. While for more sophisticated systems knowledge of the precise location of the disruption may be useful, often only the fact of intrusion in the increment or sector is necessary. The receiver may be any kind of annunciator device that is responsive to reflected energy. When an emitter is not used, the receiver will be responsive to radiation or other phenomena.

The station further includes a visualizer 60a, such as a CCTV camera. As shown in FIG. 5, its field of view extends along an arc 61 with a vector 62 controllable to point at a sensed object, or if a simpler system is desired, simply to pan onto the field within this arc. In the preferred embodiment the camera can be panned around the vertical axis of the station to look for, or look at the intrusive object.

Equally, it may be desired to tilt the camera by means of a tilt control (not shown), to learn more about the object. FIG. 4 illustrates this adjustment.

It will now be seen from FIGS. 1-5 that the series of stations provide an inter-linked path of fields into which an intruder must venture to pass to the other side. His or its entry will be detected, and can be viewed on command. The ability to view the object will eliminate response to many false alarms. Should an intruder instead attempt to destroy a station, he will succeed only in identifying himself as it senses his approach.

FIG. 1 schematically illustrates the preferred embodiment of this invention, in which continuity of the barrier is provided, and also is provided with redundancy that attends to the disablement of any station.

With reference to station 22, notice that the arcs 52 and 53 representing at least the extent of the useful field strength overlap stations 21 and 23. So does arc 71 from the field of stations 23. Thus, at least in a band 72 extending between lines 73 and 74 there is an overlap best shown by shaded area 75 in which the absence of a field from station 22 will be immaterial. The neighboring fields will cover within the band. This is the reliable sensing region.

Similarly, the fields of vision will be covered by the neighboring visualizers. The system is therefore fully redundant.

FIG. 2 shows a simpler system, in which a continuous barrier is formed as in FIG. 1, but in which redundancy is not provided. In FIG. 2, stations 80 and 81, provide respective fields 82, 83 which overlap in region 84. The extent of their electromagnetic field and visual fields may be similarly limited. Disablement of a station will be noted by a controller, but until it is repaired at least some of the area covered by the disabled station will not be fully covered, or at least not to the extent it was before.

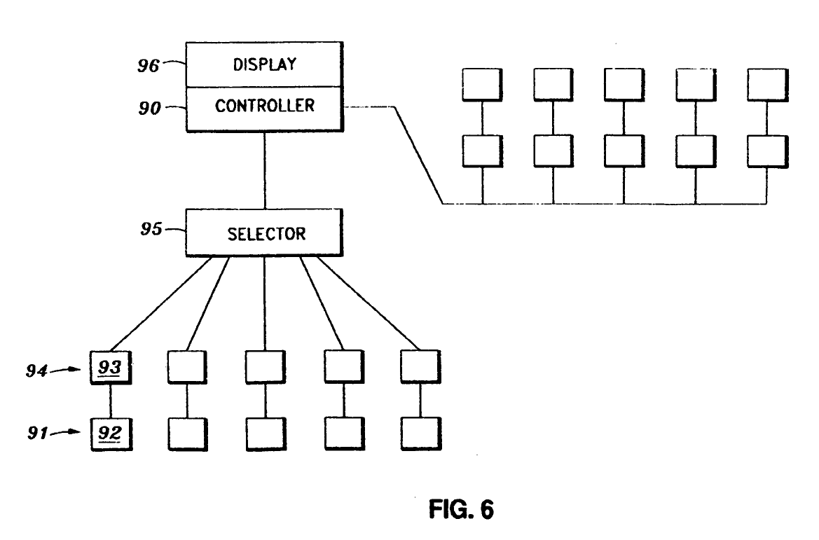

The operation and manipulation of this system is straight-forward, as shown in schematically in FIG. 6. With the system in operation, the controller 90 is alerted to signals from the individual annunciators shown in a rank 91. In the absence of a signal respective to an intrusion there is nothing for the operator to do.

When one of the sensors, perhaps sensor 92, detects an intrusion this fact is provided to a respective annunciator 93 in a rank 94 of annunciators. The controller then manipulates a selector switch 95 to connect that annunciator to a display 96.

At this time the controller will take charge of the visualizer (unless a full panorama is provided), and will pan and tilt the visualizer to find and identify the intruder. In FIG. 1 it will be noted that visualizers from the adjacent stations will also examine the images and dispatch whatever response is needed.

Except at an end station, the intrusion will occur between two stations. The closer of the stations will first alert the controller, but at the same time the two adjacent stations will preferably be actuated, perhaps by the first station, or perhaps as a system function. These can separately be displayed along with the first, thereby covering all likely events related to any of them.

When the system generates its own field such as by an emitter, or responds to radiation or reflection by or from the intruder, or vibration or heat, there is no need for sensors to be placed between the stations. The system is then fully self-contained. However, if the detection is to be that of a physical force, for example of vibration sound, or of heat, suitable detectors will be implanted and will themselves inform an annunciator of the event. Motion, vibration, and heat sensors are well-known. Any suitable type can be used.

If desired, an image of the undisturbed field can be stored, and differences from the field can be alerted and compared as a signal.

The system disclosed herein can fully supervise a long linear path, and identify an intruder so as to respond (or not to respond) appropriately.

The stations are individually self-standing. Inactivation of one does not necessarily destroy,the reliability of the system. They are readily maintained and are quite inexpensive compared to the cost of more complicated systems that often do not yield as good results.

This invention is not to be limited by the embodiments shown in the drawings and described in the description, which are given by way of example and not of limitation, but only in accordance with the scope of the appended claims.

1. A system for establishing a linear boundary subject to intrusion for detecting, annunciating and identifying the intruder, said system comprising:
a plurality of stations fixed in the surface at spaced apart increments from one another, each station having the capability of observing a sector between it and its next neighboring stations, said sectors overlapping each other at least in part, between their respective stations;
an annunciator responsive to intrusion into said increment; and
a visualizer enabling a supervisor to identify the event of intrusion.

2. A boundary system according to claim 1 in which each station is free-standing and separate from it neighbor station or stations, each station being communicable with a supervisory station.

3. A boundary system according to claim 2 in which said annunciator is a sensor selected from the group consisting of radiation detectors, acoustic detectors, motion detectors, vibration detectors, and image comparators, and competent to provide notice to a visualizer of the fact of intrusion.

4. A boundary system according to claim 3 in which each annunciator has an effective field extending at least past one-half the distance between neighboring stations, whereby to establish a continuous boundary between the two stations.

5. A boundary system according to claim 4 in which said fields extend past the next neighboring station, whereby to provide for redundancy in the event of disablement of one of the stations.

6. A boundary system according to claim 4 in which said radiation detector is responsive to radiation emitted by its respective station and reflected to it.

7. A boundary system according to claim 3 in which said station includes a camera adapted to capture an image of the region in which the intruder exists.

8. A boundary system according to claim 7 in which said camera can be tilted upwardly and downwardly, and can be panned from side to side.

9. A boundary system according to claim 2 in which said supervisory station is adapted to receive signals from a plurality of said stations.

10. a station for a boundary system adapted to form a part of linearly extending boundary comprised of a plurality of free-standing spaced apart said stations, said station having the capability of detecting and responding to an intrusion into a sector of its respective field, said station including an annunciator responsive to the intrusion, and a visualizer enabling a supervision to identify the event of intrusion.

11. A station according to claim 10 in which the annunciator is responsive to a sector selected from the group consisting of radiation detectors, acoustic detectors, motion detectors, vibration detectors, and image comparators.

12. A boundary system according to claim 11 in which said radiation detector is responsive to radiation emitted by its respective station and reflected to it.
